(19) United States
(12) Patent Application Publication
(10) Pub. No.: US 2012/0002817 A1
(43) Pub. Date: Jan. 5, 2012

(54) KEY MANAGEMENT METHOD AND KEY MANAGEMENT DEVICE

(75) Inventors: Hiroyuki WADA, Kyoto (JP); Atsushi Oida, Osaka (JP)

(73) Assignee: PANASONIC CORPORATION, Osaka (JP)

(21) Appl. No.: 13/232,545

(22) Filed: Sep. 14, 2011

Related U.S. Application Data
(63) Continuation of application No. PCT/JP2010/001443, filed on Mar. 3, 2010.

(30) Foreign Application Priority Data
Mar. 18, 2009 (JP) 2009-66113

(51) Int. Cl. H04L 9/08

(52) U.S. Cl. 380/278

(57) ABSTRACT

A validity information processing section determines a valid MKB and a valid intermediate key by referring to validity information in a recording medium, and, when an MKB and an intermediate key that are not valid have been rewritten, rewrites the validity information in the recording medium. An MKB processing section reads the valid MKB from the recording medium and performs updating processing on an MKB stored in the key management device, and rewrites the non-valid MKB in the recording medium. An intermediate key processing section reads the valid intermediate key from the recording medium and decrypts and re-encrypts the read intermediate key with an authentication key, and rewrites the non-valid intermediate key into the re-encrypted intermediate key.

### CROSS-REFERENCE TO RELATED APPLICATION

This is a continuation of PCT International Application PCT/JP2010/001443 filed on Mar. 3, 2010, which claims priority to Japanese Patent Application No. 2009-66113 filed on Mar. 18, 2009. The disclosures of these applications including the specifications, the drawings, and the claims are hereby incorporated by reference in their entirety.

### BACKGROUND

The present disclosure relates to management of key information in a recording medium, and more particularly to updating of key information.

In recent years, with the growing need for copyright protection of contents, contents provided with key and right information have been increasingly broadcast and distributed in the terrestrial digital broadcasting, the Internet, etc. To record such contents into a recording medium, it is necessary to record the key and right information safely as well as encrypting the contents. With the enhancement in the quality of contents, the encryption scheme, the key length, the scheme of device authentication, etc. are becoming more and more complicated. Also, mechanisms for resisting unauthorized copying and unauthorized use of contents have been introduced one after another.

One of such mechanisms is device invalidation using the Media Key Block (MKB), such as Content Protection for Recordable Media (CPRM) and Advanced Access Content System (AACS). With the MKB, it is possible to block unauthorized use of contents with a device used illegally due to key disclosure, etc. To keep the device invalidation meaningful, the MKB must be kept updated to the latest version through a network and an authentication device, and for this, it is necessary to check the version of the MKB mutually between the device and any recording medium at all times to ensure sharing and updating of the MKB. In other words, it is necessary to provide a mechanism of updating key information such as an authentication key and a content key, in association with updating of the MKB, safely and reliably without being noticed by the user.

Conventionally, the updating processing of key information associated with the updating of the MKB (resetting and re-encryption of keys) and the processing of writing update information obtained by this updating processing into an optical disc such as a Blu-ray disc (BD) and a digital versatile disc (DVD), a hard disc, etc. are performed by one operation at predetermined timing, thereby avoiding the situation of waiting for a response from the user, which is associated with the key updating processing of AACS, as much as possible (see Japanese Patent Publication No. 2008-22366, for example).

As content recording media, memory cards such as SD cards are available in addition to optical discs and hard discs. Memory cards were comparatively small in memory capacity in the past, and thus contents comparatively small in volume, such as a one-segment broadcast, were stored in memory cards. However, the memory capacity of memory cards has increased dramatically: nowadays, ones having a memory capacity of several tens of GB comparable to an optical disc have appeared. It is therefore expected that high-definition quality contents are to be stored in memory cards in the future. At present, CPRM has been adopted as copyright protection in memory cards. In the future, more sophisticated MKB updating processing, like that adopted for copyright protection in optical discs, must be adopted also in memory cards.

In adoption of MKB updating processing in memory cards, it is necessary to consider peculiarities in the use form of memory cards different from that of optical discs, etc. Specifically, while an optical disc won't be ejected unless the user depresses the eject button of an apparatus, for example, a memory card can be pulled out from an apparatus freely at any time at the user's discretion even if it is under being accessed. Also, because of their good portability and easiness in handling, memory cards are often used in mobile apparatuses such as mobile phones, digital still cameras, digital video cameras, and car navigation systems. Such mobile apparatuses however become powered off unintentionally in some cases. When the memory card is pulled off forcefully or power discontinuity of the apparatus occurs, data may be corrupted, and its recovery may be difficult. In particular, if such an event occurs during updating processing of key information such as an MKB and a content key, all of encrypted contents stored in the memory card may become unusable. Optical discs, hard discs, etc. will also have similar results if power discontinuity of the apparatus, etc. occur during write of key information.

In AACS, for example, in relation to updating of key information such as an MKB and a content key, it is specified that key information should be mirrored temporarily to be recoverable even if the updating processing fails. However, if renaming processing of key information is involved in the mirroring of the key information and the above event occurs during the renaming processing, file allocation tables (FAT) information of the recording medium may be corrupted, resulting in that all files stored in the recording medium may become unavailable.

Moreover, with the increase in the number of items of contents to be managed, the time required for re-encrypting the content key in the MKB updating processing has increased, and this is becoming a problem. In view of this, it has been examined to have an application key mediating between the authentication key and the content key, to encrypt/decrypt the application key with the authentication key and encrypt/decrypt the content key with the application key, not to encrypt/decrypt the content key with the authentication key. With the introduction of the application key, it is no more necessary to re-encrypt all of the content key in the MKB updating processing, but just necessary to re-encrypt the application key.

### SUMMARY

The present disclosure is advantageous in updating key information, or in particular, an MKB and an intermediate key such as an application key and a content key encrypted with an authentication key safely and reliably.

According to one aspect of the present disclosure, a key management method for managing an MKB and an intermediate key encrypted with an authentication key in a recording medium includes the steps of: when each two of MKBs and intermediate keys, as well as validity information indicating which one of each is valid, are stored in the recording medium, determining valid one each out of the stored MKBs and intermediate keys by referring to the validity information; rewriting the MKB and the intermediate key determined not to be valid into a new MKB and intermediate key; and after the rewrite of the MKB and the intermediate key, rewriting the validity information into one indicating that the rewritten MKB and intermediate key are valid.

Similarly, a key management device configured to manage an MKB and an intermediate key encrypted with an authentication key in a recording medium includes: a validity information processing section configured to, when each two of MKBs and intermediate keys, as well as validity information indicating which one of each is valid, are stored in the recording medium, determine valid one each out of the stored MKBs and intermediate keys by referring to the validity information, and, when the MKB and the intermediate key determined not to be valid have been rewritten, rewrite the validity information into one indicating that the rewritten MKB and intermediate key are valid; an MKB processing section configured to read the MKB determined to be valid and performs updating processing on an MKB stored in the key management device to generate the authentication key, and rewrite the MKB determined not to be valid into the updated MKB; and an intermediate key processing section configured to read the intermediate key determined to be valid and decrypt and re-encrypt the intermediate key with the authentication key, and rewrite the intermediate key determined not to be valid into the re-encrypted intermediate key.

According to the key management method and the key management device described above, an MKB and an intermediate key indicated as being not valid by the validity information are rewritten into a new MKB and a new intermediate key, and then the validity information is rewritten, thereby completing updating of the MKB and the intermediate key. Therefore, file renaming processing is unnecessary in the updating processing of the MKB and the intermediate key. Moreover, the time required for the updating processing of the MKB and the intermediate key can be shortened.

Preferably, the key management method described above further includes the steps of: when no validity information is stored in the recording medium, writing validity information indicating that an MKB and an intermediate key stored in the recording medium are valid; after the write of the validity information, writing a new MKB and a new intermediate key in the recording medium while leaving the MKBs and the intermediate keys stored in the recording medium as they are; and after the write of the MKB and the intermediate key, rewriting the validity information into one indicating that the written MKB and intermediate key are valid.

Similarly, preferably, in the key management device described above, when no validity information is stored in the recording medium, the validity information processing section writes validity information indicating that an MKB and an intermediate key stored in the recording medium are valid, and when another MKB and another intermediate key are written into the recording medium, the validity information processing section rewrites the validity information into one indicating that the written MKB and intermediate key are valid, the MKB processing section writes the updated MKB into the recording medium while leaving the MKBs stored in the recording medium as they are, and the intermediate key processing section writes the re-encrypted intermediate key into the recording medium while leaving the intermediate keys stored in the recording medium as they are.

According to the key management method and the key management device described above, even when no validity information is stored in the recording medium, validity information can be newly prepared, to achieve safe and reliable key information updating processing.

Preferably, the key management method described above further includes the steps of: when no validity information is stored in the recording medium, writing a new MKB and a new intermediate key in the recording medium while leaving the MKBs and the intermediate keys stored in the recording medium as they are; and after the write of the MKB and the intermediate key, writing validity information indicating that the written MKB and intermediate key are valid.

Similarly, preferably, in the key management device described above, when no validity information is stored in the recording medium, the validity information processing section determines that an MKB and an intermediate key stored in the recording medium are valid, and when another MKB and another intermediate key are written into the recording medium, the validity information processing section writes validity information indicating that the written MKB and intermediate key are valid, the MKB processing section writes the updated MKB into the recording medium while leaving the MKBs stored in the recording medium as they are, and the intermediate key processing section writes the re-encrypted intermediate key into the recording medium while leaving the intermediate keys stored in the recording medium as they are.

According to the key management method and the key management device described above, even when no validity information is stored in the recording medium, validity information can be newly prepared, to achieve safe and reliable key information updating processing. Moreover, since the newly prepared validity information is written into the recording medium at an early stage, it is unnecessary to perform FAT information updating processing associated with new write of validity information, after write of a new MKB and intermediate key. Thus, safer and more reliable key information updating processing can be achieved.

Preferably, the rewrite or write of the MKB, the intermediate key, and the validity information is performed at one stroke as a series of accesses to the recording medium. With this arrangement, the time required for rewrite or write of the MKB, the intermediate key, and the validity information can be shortened to a minimum.

Preferably, the key management method described above further includes the step of, after the rewrite or write of the MKB, verifying the rewritten or written MKB. With this step, unauthorized MKB updating can be restricted in the case that the MKB has been tampered, etc.

Preferably, the key management method described above further includes the step of, after the rewrite or write of the validity information, deleting the MKB and the intermediate key indicated as being not valid by the rewritten or written validity information from the recording medium. With this step, it is possible to make effective use of the limited memory capacity of the recording medium.

Alternatively, a key management method for managing an MKB and an intermediate key encrypted with an authentication key in a recording medium includes the steps of: duplicating an MKB stored in the recording medium to be stored in the recording medium; rewriting the original MKB into a new MKB after the duplication of the MKB; duplicating an intermediate key stored in the recording medium to be stored in the recording medium; and rewriting the original intermediate key into a new intermediate key after the duplication of the intermediate key.

Similarly, a key management device configured to manage an MKB and an intermediate key encrypted with an authentication key in a recording medium includes: an MKB processing section configured to read an MKB stored in the recording medium and perform updating processing on an MKB stored in the key management device to generate the authentication key, and also duplicate the MKB stored in the recording medium to be stored in the recording medium and rewrite the original MKB into the updated MKB; and an intermediate key processing section configured to read an intermediate key stored in the recording medium, to decrypt and re-encrypt the intermediate key with the authentication key, and also duplicate the intermediate key stored in the recording medium to be stored in the recording medium and rewrite the original intermediate key into the re-encrypted intermediate key.

According to the key management method and the key management device described above, after duplication of the MKB and the intermediate key in the recording medium, the original MKB and intermediate key are rewritten into new ones, thereby completing updating of the MKB and the intermediate key. Therefore, file renaming processing is unnecessary in the updating processing of the MKB and the intermediate key.

Preferably, the rewrite of the MKB and the intermediate key is performed at one stroke as a series of accesses to the recording medium. With this arrangement, the time required for rewrite of the MKB and the intermediate key can be shortened to a minimum.

Preferably, the key management method described above further includes the step of, after the rewrite of the MKB, verifying the rewritten MKB. With this step, unauthorized MKB updating can be restricted in the case that the MKB has been tampered, etc.

Preferably, the key management method described above further includes the steps of: after the rewrite of the MKB, deleting the duplicated MKB from the recording medium; and after the rewrite of the intermediate key, deleting the duplicated intermediate key from the recording medium. With these steps, it is possible to make effective use of the limited memory capacity of the recording medium.

### BRIEF DESCRIPTION OF THE DRAWINGS

FIG. 1 is a block diagram of a content reproduction system of an embodiment.

FIG. 2 is a flowchart of key information updating processing.

FIG. 3 is a block diagram of a content reproduction system of a variation of the embodiment.

FIG. 4 is a flowchart of key information updating processing in the variation.

### DETAILED DESCRIPTION

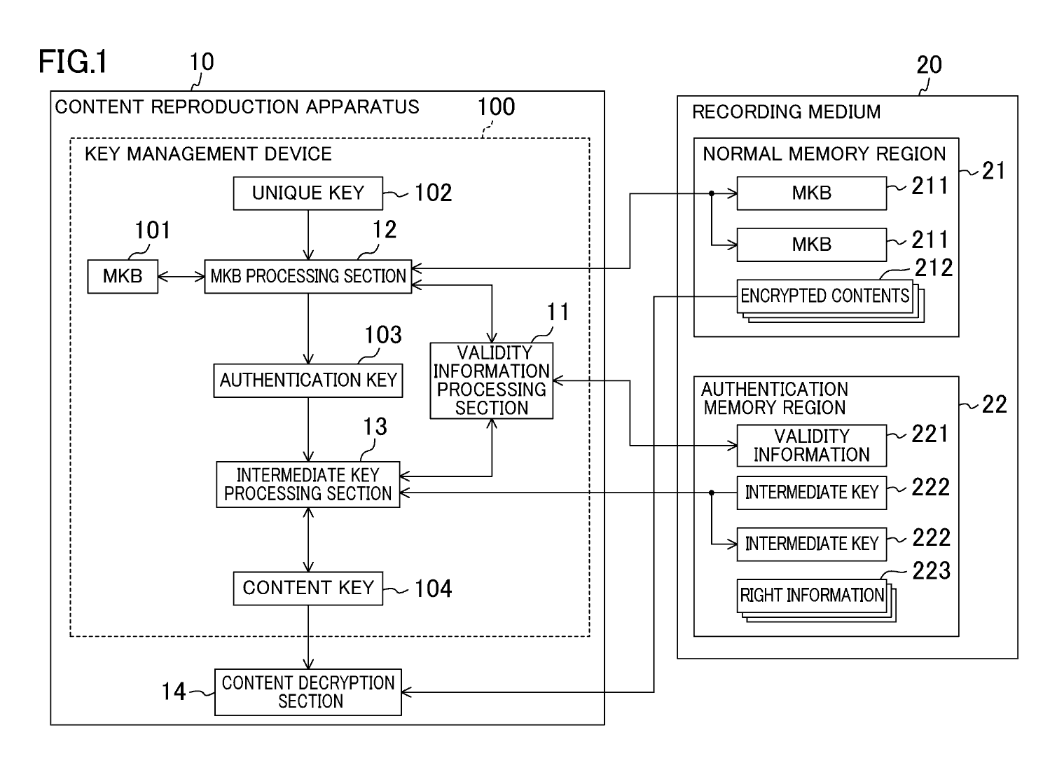

FIG. 1 shows a configuration of a content reproduction system of an embodiment. This system is configured to reproduce encrypted contents recorded in a recording medium 20 by a content reproduction apparatus 10. Note that, although the present disclosure will be described hereinafter for the case of reproducing contents recorded in the recording medium 20, this can also be applied to the case of recording contents into the recording medium 20 in a similar manner.

The recording medium 20 is a BD, a DVD, a memory card, etc., for example. The content reproduction apparatus 10 is a digital broadcasting TV receiver, a digital broadcasting recorder, a personal computer, a mobile phone, a digital still camera, a digital video camera, a mobile content viewer, etc., for example. Specifically, a situation as follows is assumed: high-quality contents digital-broadcast or distributed via the Internet are recorded in a recording medium such as a memory card by a consumer apparatus such as a recorder, and the memory card taken out is inserted into any of other various apparatuses, or the apparatuses are connected to each other via a network, to allow the recorded high-quality contents to be reproduced by any of various apparatuses.

The recording medium 20 includes a normal memory region 21 accessible without the necessity of mutual authentication with the content reproduction apparatus 10 and an authentication memory region 22 accessible only after mutual authentication. In the normal memory region 21, two MKBs 211 and one item or a plurality of items of encrypted contents 212 are stored. In the authentication memory region 22, validity information 221, two intermediate keys 222, and one unit or a plurality of units of right information 223 are stored. The intermediate keys 222 are specifically content keys or application keys. The encrypted contents 212 are contents encrypted with an intermediate key 222 as a content key, or contents encrypted with a content key that is encrypted with an intermediate key 222 as an application key. The right information 223 includes right information such as the number of times of copying permitted set by a content provider for each item of encrypted contents 212. The validity information 221 is information indicating which one of each of the two MKBs 211 and the two intermediate keys 222 is valid.

The content reproduction apparatus 10 includes: a key management device 100 that manages the MKBs 211 and the intermediate keys 222 in the recording medium 20; and a content decryption section 14. The content decryption section 14 decrypts the encrypted contents 212 read from the recording medium 20 with a content key 104 generated by the key management device 100.

In the key management device 100, a validity information processing section 11 determines valid one each from the two MKBs 211 and the two intermediate keys 222 stored in the recording medium 20 by referring to the validity information 221. Also, when the MKB 211 and the intermediate key 222 determined not to be valid have been rewritten, the validity information processing section 11 rewrites the validity information 221 to indicate that the rewritten MKB and intermediate key are valid.

An MKB processing section 12 reads the MKB 211 determined to be valid, to perform updating processing on an MKB 101 stored in the key management device 100, and generates an authentication key 103 for accessing the authentication memory region 22 from an unique key 102 of the key management device 100. Also, the MKB processing section 12 rewrites the MKB 211 determined not to be valid into the updated MKB 101.

When the intermediate keys 222 are content keys, an intermediate key processing section 13 performs mutual authentication with the recording medium 20 using the authentication key 103, reads the intermediate key 222 that is stored in the authentication memory region 22 and has been determined to be valid, decrypts the read intermediate key 222 with the authentication key 103 to generate the content key 104. Also, the intermediate key processing section 13 re-encrypts the content key 104 with the authentication key 103, and rewrites the intermediate key 222 determined not to be valid into the re-encrypted content key.

When the intermediate keys 222 are application keys, the intermediate key processing section 13 decrypts the read intermediate key 222 with the authentication key 103, and moreover reads an encrypted content key stored in the authentication memory region 22 although not shown and decrypts the content key with the decrypted application key, to generate the content key 104. Also, the intermediate key processing section 13 re-encrypts the application key with the authentication key 103, and rewrites the intermediate key 222 determined not to be valid into the re-encrypted application key.

Whether to update the MKB or not is determined in the following procedure. Note that, although the following procedure is based on AACS, a procedure conforming to any other standard may also be adopted.

First, verification information, such as the signature and the hash value, of the MKB 101 stored in the key management device 100 is calculated, and whether or not the calculated verification information is equal to verification information such as the signature and the hash value recorded in advance in the MKB 101 is checked. If they are equal to each other, this indicates that the MKB 101 has not been tampered, and thus the version of the MKB 101 is checked. Also, the valid one out of the two MKBs 211 stored in the recording medium 20 is also subjected to similar verification work, and the version of the valid MKB 211 is checked.

Next, the version of the MKB 101 is compared with that of the valid MKB 211, and, if the latter is newer than the former, the MKB 101 is overwritten with the valid MKB 211. In this case, since updating of the MKB 211 is unnecessary, updating of the intermediate key 222 stored in the recording medium 20 is also unnecessary. In other words, only overwrite of the MKB 101 is necessary. If the former is newer than the latter, the MKB 211 stored in the recording memory 20 must be updated. Moreover, with updating of the MKB 211, updating of the intermediate key 222 stored in the recording medium 20 is also necessary. In other words, this case involves updating processing of the MKB 211 and the intermediate key 222 in the recording medium 20. If this updating processing fails, it may become impossible to reproduce all the encrypted contents 212. Therefore, the key management device 100 of this embodiment performs updating processing of the MKB 211 and the intermediate key 222 safely and reliably in accordance with the following procedure.

The updating processing of the MKB 211 and the intermediate key 222 may be performed at any of various occasions as follows: immediately after insertion of the recording medium 20 into the content reproduction apparatus 10 or immediately before ejection of the recording medium 20 from the content reproduction apparatus 10; immediately after start or immediately before exit of a compliant application; immediately before start or immediately after completion of reproduction of the encrypted contents 212; immediately before start or immediately after completion of recording of the encrypted contents 212 into the recording medium 20; immediately after startup or immediately before shutdown of the content reproduction apparatus 10 in which the recording medium 20 is placed. These specific occasions depend on the content reproduction apparatus 10, and other occasions may be used.

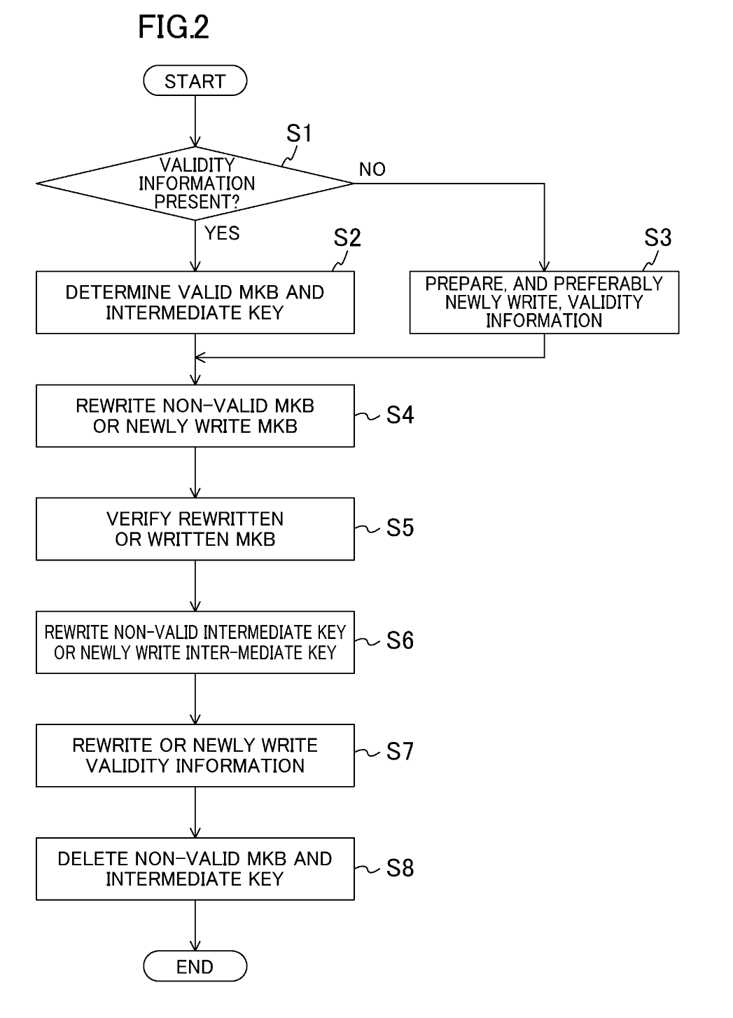

Key information updating processing by the key management device 100 will be described hereinafter with reference to the flowchart of FIG. 2. First, whether the validity information 221 is present or not in the recording medium 20 is checked (step S1). If the validity information 221 is present (YES in step S1), valid one each out of the two MKBs 211 and the two intermediate keys 222 is determined by referring to the validity information 221 (step S2). If the validity information 221 is not present (NO in step S1), validity information indicating that an MKB 211 and an intermediate key 222 stored in the recording medium 20 are valid is prepared (step S3). The prepared validity information may be temporarily held in the key management device 100 to be written into the recording medium 20 later (specifically, after updating of the MKB and the intermediate key to be described later). It is however preferable to write the prepared validity information into the recording medium 20 at this time point. A comparatively long time is necessary to write the new validity information 221 into the recording medium 20 because FAT in the recording medium 20 must be updated. By finishing such time-consuming processing at this time point, updating processing of the validity information 221 to be performed after rewrite or new write of the MKB and the intermediate key to be described later can be completed speedily.

After the determination of the valid MKB 211 and intermediate key 222 in the recording medium 20, the MKB 211 determined not to be valid is rewritten into the new-version MKB. Alternatively, while the MKBs 211 stored in the recording medium 20 are left as they are, the new-version MKB is newly written as another MKB 211 (step S4). The new-version MKB is the MKB 101 stored in the key management device 100. Thereafter, the rewritten or newly-written MKB 211 is read from the recording medium 20, to be subjected to check on whether the verification information of the read MKB 211 is equal to that of the MKB 101 (step S5). In other words, whether the rewritten or newly-written MKB 211 has been tampered or not is checked. The step S5 may be omitted.

Similarly to the step S4, the intermediate key 222 determined not to be valid is rewritten into the latest intermediate key. Alternatively, while the intermediate keys 222 stored in the recording medium 20 are left as they are, the latest intermediate key is newly written as another intermediate key 222 (step S6). The latest intermediate key is one re-encrypted by the intermediate key processing section 13 of the key management device 100.

When the rewrite or new write of the MKB 211 and the intermediate key 222 has been completed, the validity information 221 is rewritten into one indicating that the rewritten or newly-written MKB 211 and intermediate key 222 are valid, or, if the validity information 221 has not been newly written into the recording medium 20 in the step S3, the validity information 221 having the above indication is newly written (step S7). That is, the valid MKB 211 and the valid intermediate key 222 are switched from one to the other. Thus, in the subsequent access to the recording medium 20, the rewritten or newly-written MKB 211 and intermediate key 222 are subjected to determination.

In the case where a limitation is posed in the memory capacity for the key information in the recording medium 20, etc., the MKB 211 and the intermediate key 222 indicated as being not valid by the validity information 221 may be deleted from the recording medium 20 after completion of rewrite or new write of the validity information 221 (step S8). The step S8 may be omitted.

In the key information updating processing described above, it is preferable that the key management device 100 has already prepared the new-version MKB and the latest intermediate key before the step S4, and the steps S4, S6, and S7 are performed at one stroke as a series of accesses to the recording medium 20. That is, the updating processing of the MKB 211, the intermediate key 222, and the validity information 221 is a type of processing of which suspension is prohibited. By performing such processing by one operation at one stroke, the time required for such critical processing can be shortened to a minimum.

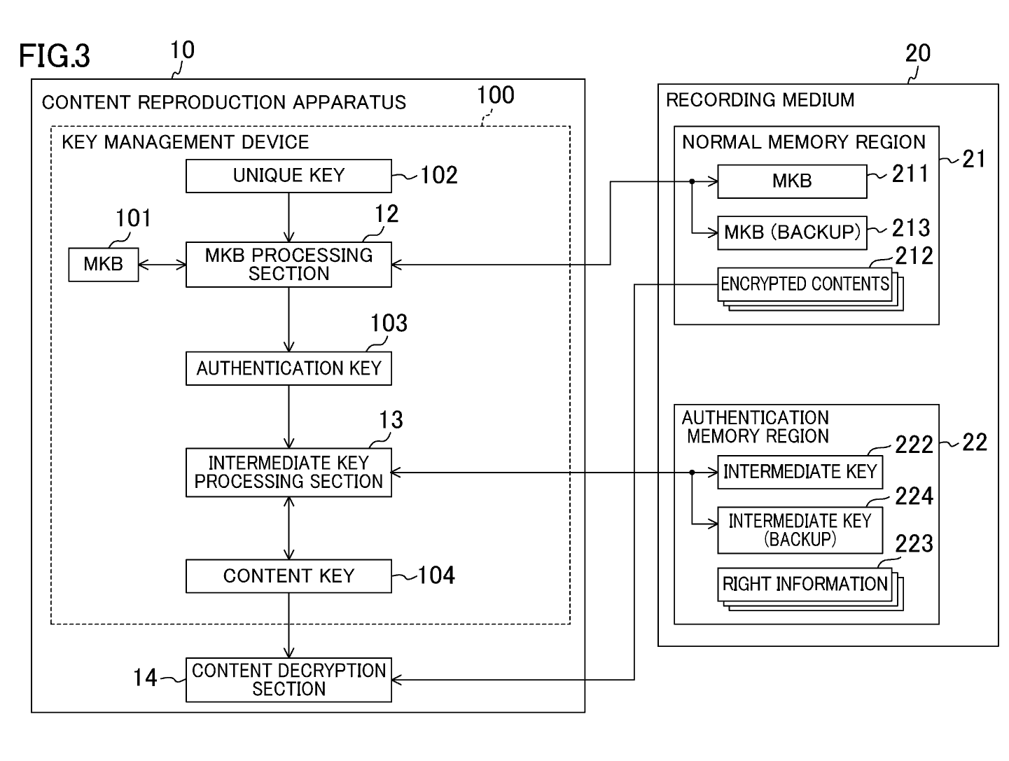

The validity information 221 may be stored in the normal memory region 21, or otherwise may be omitted. When the validity information 221 is omitted, the validity information processing section 11 can also be omitted (see FIG. 3). A variation that does not use the validity information 221 will be described hereinafter.

With omission of the validity information 221 and the validity information processing section 11, there are only one valid MKB 211 and only one valid intermediate key 222 in the recording medium 20. The MKB processing section 12 reads the MKB 211 from the recording medium 20, to perform updating processing on the MKB 101 stored in the key management device 100, and generates the authentication key 103 for accessing the authentication memory region 22 from the unique key 102 of the key management device 100. Also, the MKB processing section 12 prepares an MKB 213 that is a duplicate of the MKB 211 stored in the recording medium 20, to be stored in the recording medium 20, and then rewrites the original MKB 211 into the updated MKB 101. Thereafter, the MKB processing section 12 deletes the MKB 213 from the recording medium 20 as required. In this way, by backing up the MKB 211 before rewrite of the MKB 211, i.e., by preparing the MKB 213, the MKB 211 can be recovered from the MKB 213 even if rewrite of the MKB 211 fails.

When the intermediate key 222 is a content key, the intermediate key processing section 13 performs mutual authentication with the recording medium 20 using the authentication key 103, reads the intermediate key 222 stored in the authentication memory region 22, and decrypts the read intermediate key 222 with the authentication key 103 to generate the content key 104. Also, the intermediate key processing section 13 re-encrypts the content key 104 with the authentication key 103. Moreover, the intermediate key processing section 13 prepares an intermediate key 224 that is a duplicate of the intermediate key 222 stored in the recording medium 20, to be stored in the recording medium 20, and then rewrites the original intermediate key 222 into the re-encrypted content key.

When the intermediate key 222 is an application key, the intermediate key processing section 13 decrypts the read intermediate key 222 with the authentication key 103, and moreover reads an encrypted content key stored in the authentication memory region 22 although not shown and decrypts the content key with the decrypted application key, to generate the content key 104. Also, the intermediate key processing section 13 re-encrypts the application key with the authentication key 103. Moreover, the intermediate key processing section 13 prepares an intermediate key 224 that is a duplicate of the intermediate key 222 stored in the recording medium 20, to be stored in the recording medium 20, and then rewrites the original intermediate key 222 into the re-encrypted application key.

Thereafter, the intermediate key processing section 13 deletes the intermediate key 224 from the recording medium 20 as required. In this way, by backing up the intermediate key 222 before rewrite of the intermediate key 222, i.e., by preparing the intermediate key 224, the intermediate key 222 can be recovered from the intermediate key 224 even if rewrite of the intermediate key 222 fails.

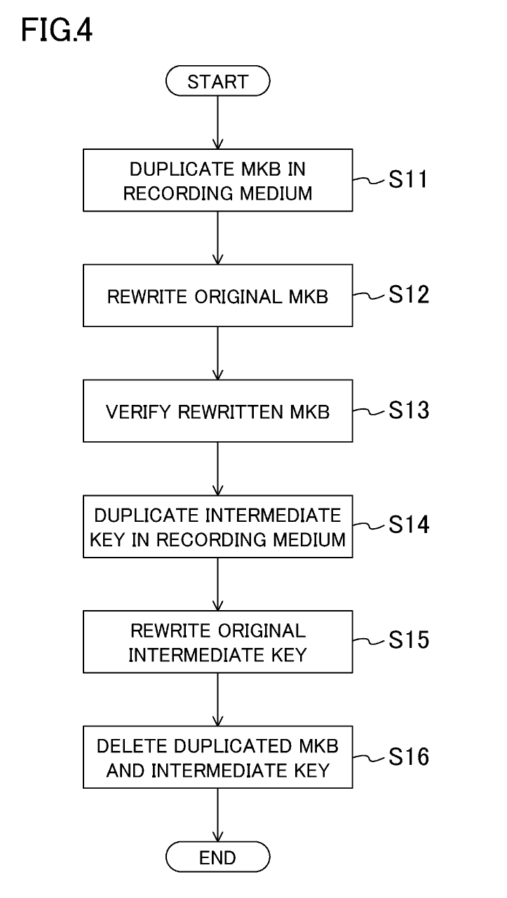

Key information updating processing without use of validity information 221 will be described hereinafter with reference to the flowchart of FIG. 4. First, the MKB 211 stored in the recording medium 20 is duplicated in the recording medium 20 (step S11), and, after the duplication, the original MKB 211 is rewritten into the new-version MKB (step S 12). The rewritten MKB 211 is then verified (step S13). The step S13 may be omitted. Similarly, the intermediate key 222 stored in the recording medium 20 is duplicated in the recording medium 20 (step S 14), and, after the duplication, the original intermediate key 222 is rewritten into the latest intermediate key (step S 15). After completion of rewrite of both the MKB 211 and the intermediate key 222, the duplicated MKB 213 and the duplicated intermediate key 224 are deleted (step S 16). The step S16 may be omitted.

As described above, in this embodiment, the MKB 211 and the intermediate key 222 can be subjected to updating processing without the necessity of file renaming processing in the recording medium 20. Thus, the time required for the updating processing of the MKB 211 and the intermediate key 222 can be shortened. This reduces the possibility of occurrence of an unexpected trouble such as forceful ejection of the recording medium 20 and power shutdown of the content reproduction apparatus 10 during updating processing of the key information in the recording medium 20, and thus safe and reliable key information updating processing can be achieved.

What is claimed is:

1. A key management method for managing an MKB and an intermediate key encrypted with an authentication key in a recording medium, comprising the steps of:
when each two of MKBs and intermediate keys, as well as validity information indicating which one of each is valid, are stored in the recording medium, determining valid one each out of the stored MKBs and intermediate keys by referring to the validity information;
rewriting the MKB and the intermediate key determined not to be valid into a new MKB and intermediate key; and
after the rewrite of the MKB and the intermediate key, rewriting the validity information into one indicating that the rewritten MKB and intermediate key are valid.

2. The key management method of claim 1, further comprising the steps of:
when no validity information is stored in the recording medium, writing validity information indicating that an MKB and an intermediate key stored in the recording medium are valid;
after the write of the validity information, writing a new MKB and a new intermediate key in the recording medium while leaving the MKBs and the intermediate keys stored in the recording medium as they are; and
after the write of the MKB and the intermediate key, rewriting the validity information into one indicating that the written MKB and intermediate key are valid.

3. The key management method of claim 1, further comprising the steps of:
when no validity information is stored in the recording medium, writing a new MKB and a new intermediate key in the recording medium while leaving the MKBs and the intermediate keys stored in the recording medium as they are; and
after the write of the MKB and the intermediate key, writing validity information indicating that the written MKB and intermediate key are valid.

4. The key management method of claim 1, wherein
the rewrite of the MKB, the intermediate key, and the validity information is performed at one stroke as a series of accesses to the recording medium.

5. The key management method of claim 2, wherein
the write of the MKB and the intermediate key and the rewrite of the validity information are performed at one stroke as a series of accesses to the recording medium.

6. The key management method of claim 3, wherein
the write of the MKB, the intermediate key, and the validity information is performed at one stroke as a series of accesses to the recording medium.

7. The key management method of claim 1, further comprising the step of:
after the rewrite of the MKB, verifying the rewritten MKB.

8. The key management method of claim 2, further comprising the step of:
after the write of the MKB, verifying the written MKB.

9. The key management method of claim 3, further comprising the step of:
after the write of the MKB, verifying the written MKB.

10. The key management method of claim 1, further comprising the step of:
after the rewrite of the validity information, deleting the MKB and the intermediate key indicated as being not valid by the rewritten validity information from the recording medium.

11. The key management method of claim 2, further comprising the step of:
after the rewrite of the validity information, deleting the MKB and the intermediate key indicated as being not valid by the rewritten validity information from the recording medium.

12. The key management method of claim 3, further comprising the step of:
after the write of the validity information, deleting the MKB and the intermediate key indicated as being not valid by the written validity information from the recording medium.

13. A key management method for managing an MKB and an intermediate key encrypted with an authentication key in a recording medium, comprising the steps of:
duplicating an MKB stored in the recording medium to be stored in the recording medium;
rewriting the original MKB into a new MKB after the duplication of the MKB;
duplicating an intermediate key stored in the recording medium to be stored in the recording medium; and
rewriting the original intermediate key into a new intermediate key after the duplication of the intermediate key.

14. The key management method of claim 13, wherein
the rewrite of the MKB and the intermediate key is performed at one stroke as a series of accesses to the recording medium.

15. The key management method of claim 13, further comprising the step of:
after the rewrite of the MKB, verifying the rewritten MKB.

16. The key management method of claim 13, further comprising the steps of:
after the rewrite of the MKB, deleting the duplicated MKB from the recording medium; and
after the rewrite of the intermediate key, deleting the duplicated intermediate key from the recording medium.

17. A key management device configured to manage an MKB and an intermediate key encrypted with an authentication key in a recording medium, comprising:
a validity information processing section configured to, when each two of MKBs and intermediate keys, as well as validity information indicating which one of each is valid, are stored in the recording medium, determine valid one each out of the stored MKBs and intermediate keys by referring to the validity information, and, when the MKB and the intermediate key determined not to be valid have been rewritten, rewrite the validity information into one indicating that the rewritten MKB and intermediate key are valid;
an MKB processing section configured to read the MKB determined to be valid and performs updating processing on an MKB stored in the key management device to generate the authentication key, and rewrite the MKB determined not to be valid into the updated MKB; and
an intermediate key processing section configured to read the intermediate key determined to be valid and decrypt and re-encrypt the intermediate key with the authentication key, and rewrite the intermediate key determined not to be valid into the re-encrypted intermediate key.

18. The key management device of claim 17, wherein
when no validity information is stored in the recording medium, the validity information processing section writes validity information indicating that an MKB and an intermediate key stored in the recording medium are valid, and when another MKB and another intermediate key are written into the recording medium, the validity information processing section rewrites the validity information into one indicating that the written MKB and intermediate key are valid,
the MKB processing section writes the updated MKB into the recording medium while leaving the MKBs stored in the recording medium as they are, and
the intermediate key processing section writes the re-encrypted intermediate key into the recording medium while leaving the intermediate keys stored in the recording medium as they are.

19. The key management device of claim 17, wherein
when no validity information is stored in the recording medium, the validity information processing section determines that an MKB and an intermediate key stored in the recording medium are valid, and when another MKB and another intermediate key are written into the recording medium, the validity information processing section writes validity information indicating that the written MKB and intermediate key are valid,
the MKB processing section writes the updated MKB into the recording medium while leaving the MKBs stored in the recording medium as they are, and
the intermediate key processing section writes the re-encrypted intermediate key into the recording medium while leaving the intermediate keys stored in the recording medium as they are.

20. A key management device configured to manage an MKB and an intermediate key encrypted with an authentication key in a recording medium, comprising:
an MKB processing section configured to read an MKB stored in the recording medium and perform updating processing on an MKB stored in the key management device to generate the authentication key, and also duplicate the MKB stored in the recording medium to be stored in the recording medium and rewrite the original MKB into the updated MKB; and
an intermediate key processing section configured to read an intermediate key stored in the recording medium, to decrypt and re-encrypt the intermediate key with the authentication key, and also duplicate the intermediate key stored in the recording medium to be stored in the recording medium and rewrite the original intermediate key into the re-encrypted intermediate key.

21. A content reproduction apparatus configured to reproduce encrypted contents stored in a recording medium, comprising:
the key management device of claim 17; and
a content decryption section configured to read the encrypted contents from the recording medium and decrypt the read encrypted contents with an intermediate key decrypted by an intermediate key processing section of the key management device or with a content key decrypted with the intermediate key.

22. A content reproduction apparatus configured to reproduce encrypted contents stored in a recording medium, comprising:
the key management device of claim 20; and
a content decryption section configured to read the encrypted contents from the recording medium and decrypt the read encrypted contents with an intermediate key decrypted by an intermediate key processing section of the key management device or with a content key decrypted with the intermediate key.
